(19) United States
(12) Patent Application Publication
(10) Pub. No.: US 2014/0374485 A1
(43) Pub. Date: Dec. 25, 2014

(54) System and Method for Reading Code Symbols Using a Variable Field of View

(71) Applicant: Hand Held Products, Inc., Fort Mill, SC (US)

(72) Inventors: Tao Xian, Bordentown, NJ (US); Yong Liu, Suzhou (CN); Ynjiun Paul Wang, Cupertino, CA (US); Jun Lu, Suzhou (CN)

(21) Appl. No.: 13/922,339

(22) Filed: Jun. 20, 2013

(51) Int. Cl. G06K 7/10

(52) U.S. Cl. CPC G06K 7/10603
USPC 235/462.22

(57) ABSTRACT

A system and method are presented for improving the performance of full range code scanners. A distance detection module determines the distance of the code symbol from the code symbol reader. In response to the detected distance, the sweep angle of the scanning element is changed to ensure that the code symbol is within the code symbol reader's field of view. The sweep angle is larger when the code symbol is in the near range, and smaller when the code symbol is in the far range.

### FIELD OF THE INVENTION

The disclosure relates generally to improvements in reading code symbols, and more particularly, to a system and method for reading code symbols using a variable field of view.

### BACKGROUND OF THE DISCLOSURE

A code symbol reading device (e.g., barcode scanner, barcode reader, RFID reader) is a specialized input device for certain data systems commonly used by retailers, industrial businesses, and other businesses having a need to manage large amounts of inventory. Code symbol reading devices are often employed to read barcodes. A barcode is a machine-readable representation of information in a graphic format. The most familiar of these graphic symbols is a series of parallel bars and spaces of varying widths, which format gave rise to the term “barcode.”

Most barcode scanners operate by projecting light from an LED or a laser onto the printed barcode, and then detecting the level of reflected light as the light beam sweeps across the barcode. Using this technique, the barcode scanner is able to distinguish between. dark areas and light areas on the barcode. More light is reflected from the light areas on the barcode than the dark areas, so the optical energy reflected back to the barcode scanner will be a signal containing a series of peaks corresponding to the light areas and valleys corresponding to the dark areas. A processor converts the received optical signal into an electrical signal. The processor decodes the peaks and valleys of the signal to decode the information (e.g., product number) represented by the code symbol.

Barcode scanners have historically been designed to read barcodes in the near range (e.g., barcodes located less than about three feet from the barcode scanner). Recently, however, advancements have been made in developing barcode scanners capable of reliably reading barcodes in the far range (e.g., barcode located about 30 feet or more from the barcode scanner). Full range barcode scanners have the capability of reading barcodes in both the near range and the far range. Although full range barcode scanners afford the user great flexibility, there are inherent design challenges in enabling the scanner's ability to read barcodes at varying distances. Typically, full range barcode scanners have a fixed, relatively small (e.g., 10 to 15 degrees) field of view. The field of view is the scanning field defined by the area swept by the scanning laser. A barcode must be completely within the field of view for the scanner to read (e.g., decode) the barcode.

The narrow field of view of a full range barcode scanner improves its ability to read barcodes in the far range by providing better aiming and improved signal intensity. This narrow field of view creates problems when attempting to scan barcodes in the near field. When the barcode is relatively close to the barcode scanner, the narrow field of view sometimes means that the sweep of the laser is not wide enough to cover the entire barcode. This inhibits the ability of the scanner to read the barcode, and can result in frustration for the user.

There is therefore a need for a full range scanner that is capable of reliably reading barcodes in both the far range and the near range. There is a need for a full range barcode scanner that can maintain the barcode within its field of view in both the far range and the near range.

### SUMMARY OF THE INVENTION

In one aspect, the disclosure embraces a system for reading code symbols. The system includes a source for generating a light beam (e.g., a laser source, infrared light source, CCD). The system also includes a scanning element for scanning the light beam at a sweep angle across a scanning field. A photodetector (e.g., photodiode, photoreceptor) detects the intensity of light reflected from the scanning field and generates a first signal corresponding to the detected light intensity. A distance detection module determines the distance between the system and the code symbol (e.g., barcode). In one embodiment, the distance detection module is a processor. Typically, the processor determines the distance between the system and the code symbol based upon the first signal. In an alternative embodiment, the distance detection module is an infrared sensor (IR sensor). In one embodiment, when the detected distance between the system and the code symbol is in a near range (e.g., less than about seventeen feet), the scanning element scans the light beam at a first sweep angle, and when the detected distance is in a far range (e.g., greater than about seventeen feet), the scanning element scans the light beam at a second sweep angle. Typically, the first sweep angle is larger than the second sweep angle.

In another aspect, the disclosure embraces a method for reading code symbols with a code symbol reader. A light beam is generated and scanned at a sweep angle across a scanning field. The intensity of the light reflected from the scanning field is detected. A first signal corresponding to the detected intensity of light reflected from the scanning field is generated. A distance between the code symbol reader and an object in the scanning field is determined. The size of the sweep angle is controlled in response to the determined distance between the code symbol reader and the object.

### BRIEF DESCRIPTION OF THE DRAWINGS

FIG. 1 is a perspective view of an exemplary embodiment of a code symbol reading system according to the present invention.

FIG. 2 is a schematic block diagram describing the major system components of an exemplary code symbol reading system according to the present invention.

FIG. 3 is a schematic block diagram describing the major system components of an exemplary code symbol reading system according to the present invention.

FIG. 4 is a schematic block diagram describing the major system components of an exemplary code symbol reading system according to the present invention.

### DETAILED DESCRIPTION

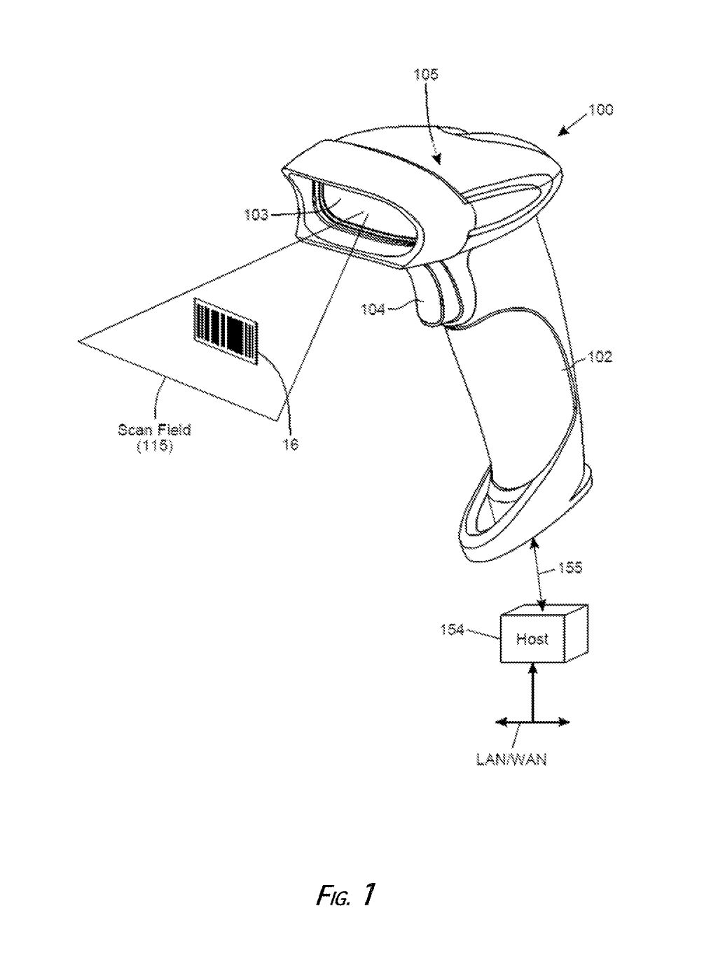

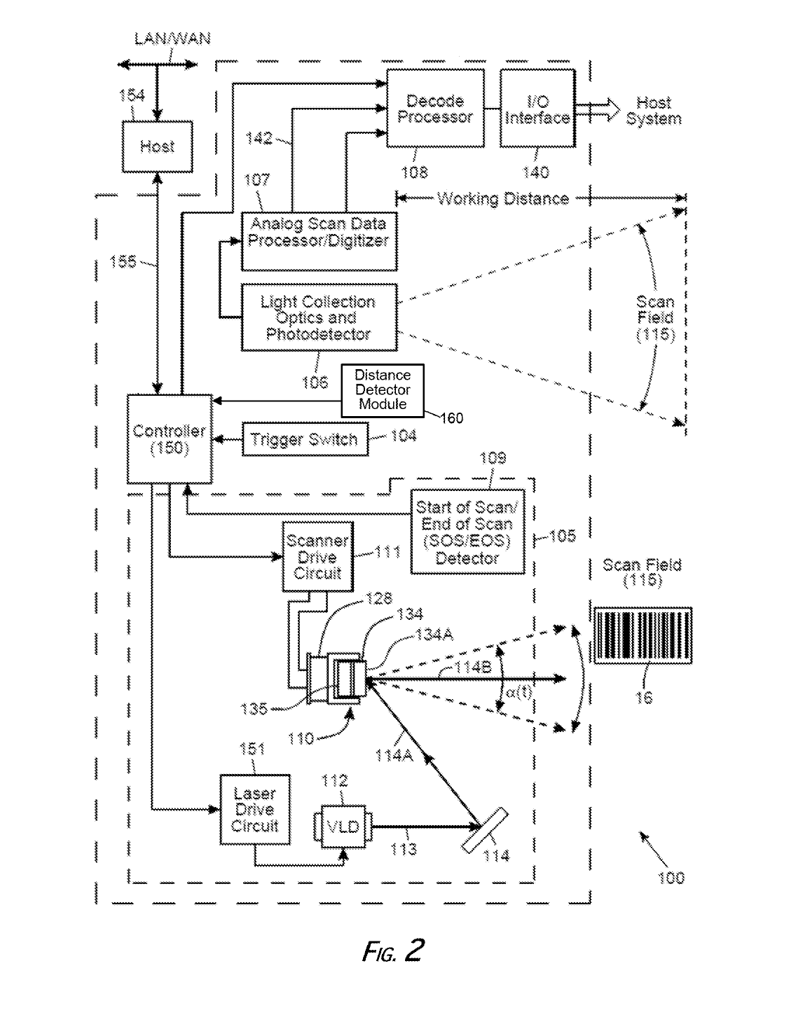

Referring to the figures in the accompanying drawings, the illustrative embodiments of the code symbol reading system according to the present invention will be described in great detail, where like elements will be indicated using like reference numerals. Turning now to the drawings, FIGS. 1 and 2 depict an exemplary code symbol reading system according to the present invention. The code symbol reading system 100 has a housing 102 having a head portion and a handle portion supporting the head portion. A light transmission window 103 is integrated with the head portion of the housing 102. A trigger switch 104 is integrated with the handle portion of the housing 102. The trigger switch 104 is for generating a trigger event signal to activate a scanning module 105. The scanning module 105 repeatedly scans across its scanning field 115 a light beam (e.g., a visible laser beam) generated by a source for generating a light beam 112 (e.g., a laser source, VLD or IR LD). The laser source 112 has optics to produce a laser scanning beam focused in the scanning field 115 in response to control signals generated by a controller 150. The scanning module 105 also includes a laser driver 151 for receiving control signals from the controller 150, and in response thereto, generating and delivering laser (diode) drive current signals to the laser source 112. A start of scan/end of scan (SOS/EOS) detector 109 generates timing signals indicating the start of a light beam (e.g., laser beam) sweep and the end of a light beam sweep, and sends those timing signals to the controller 150 and a decode processor 108. Light collection optics collect light that has been reflected or scattered from a scanned object in the scanning field 115, and a photodetector 106 detects the intensity of the collected light. The photodetector 106 generates an analog scan data signal (e.g., a first signal) corresponding to the detected light intensity during scanning operations. An analog scan data signal processor/digitizer 107 processes the analog scan data signals and converts the processed analog scan data signals into digital scan data signals. The digital scan data signals are converted into digital words representative of the relative width of the bars and spaces in the scanned code symbol. The digital words are transmitted to a decode processor 108 via lines 142. The decode processor 108 generates symbol character data representative of each code symbol scanned by the laser beam. An input/output (IO) communication interface module 140 interfaces with a host device 154. It is through this IO communication module 140 that the symbol character data is transmitted to the host device 154, which transmission may be done through wired (eg., USB, RS-232) or wireless (e.g., Bluetooth) communication links 155 between the code symbol reading system 100 and the host device 154.

The controller 150 generates the necessary control signals to control operations within the code symbol reading system 100. The laser scanning module 105 includes several subcomponents. A scanning assembly 110 has an electromagnetic coil 128 and rotatable scanning element 134 (e.g., mirror) supporting a lightweight reflective element (e.g., mirror) 134A. A coil drive circuit 111 generates an electrical drive signal to drive the electromagnetic coil 128 in the scanning assembly 110. The laser source 112 generates a visible laser beam 113. A beam deflecting mirror 114 deflects the laser beam 113 as an incident beam 114A towards the scanning element 134 of the scanning assembly 110, which sweeps the deflected laser beam 114B across the laser scanning field 115 containing a code symbol (e.g., barcode) 16.

As shown in FIG. 2, the scanning module 105 is typically mounted on an optical bench, printed circuit (PC) board or other surface where the scanning assembly 110 is also, and includes a coil support portion 110 for supporting the electromagnetic coil 128 (in the vicinity of the permanent magnet 135) and which is driven by a scanner drive circuit 111 so that it generates magnetic forces on opposite poles of the permanent magnet 135, during scanning assembly operation. Assuming the properties of the permanent magnet 135 are substantially constant, as well as the distance between the permanent magnet 135 and the electromagnetic coil 128, the force exerted on the permanent magnet 135 and its associated scanning element is a function of the electrical drive current I_{DC}(t) supplied to the electromagnetic coil 128 during scanning operations. In general, the greater the level of drive current I_{DC}(t) produced by scanner drive circuit 111, the greater the forces exerted on permanent magnet 135 and its associated scanning element 134. Thus, scan sweep angle α(t) of the scanning module 105 can be directly controlled by controlling the level of drive current I_{DC}(t) supplied to the coil 128 by the scanner drive circuit 111 under the control of controller 150, shown in FIG. 2.

In response to the manual actuation of trigger switch 104, the scanning module 105 generates and projects a laser scanning beam through the light transmission window 103, and across the scanning field 115 external to the housing 102, for scanning an object in the scanning field 115. The laser scanning beam is generated by the laser source 112 in response to control signals generated by the controller 150. The scanning element 134 repeatedly sweeps the laser beam across the object in the scanning field 115 at the scan sweep angle α(t) set by the controller 150 during scanning operation. The scanning element 134 can sweep across scanning fields of varying size, therefore it has a maximum sweep angle representing the largest scanning field it scan sweep and a minimum sweep angle representing the smallest. Then, the light collection optics 106 collects light reflected/scattered from scanned code symbols on the object in the scanning field, and the photodetector (106) automatically detects the intensity of collected light (i.e. photonic energy) and generates an analog scan data signal (e.g., a first electrical signal) corresponding to the light intensity detected during scanning operations.

A distance detector module 160 detects the distance between the system 100 and the code symbol 16 in the scan field 115. The sweep angle is adjusted based upon the detected distance. Typically, when the detected distance indicates that the code symbol 16 is in the far range (e.g., greater than about seventeen feet), the scanning assembly 110 will generate a relatively small sweep angle. Conversely, when the detected distance indicates that the code symbol 16 is in the near range (e.g., less than about seventeen feet), the scanning assembly 110 will generate a relatively large sweep angle. Employing a smaller sweep angle in the far range improves the ability of the user to aim the laser beam at the code symbol and enhances the intensity of the reflected light received by the photodetector 106. Employing a larger sweep angle when the code symbol 16 is in the near range increases the likelihood that the entire code symbol 16 will fit within the system's 100 field of view, thereby increasing the likelihood of a successful read of the code symbol.

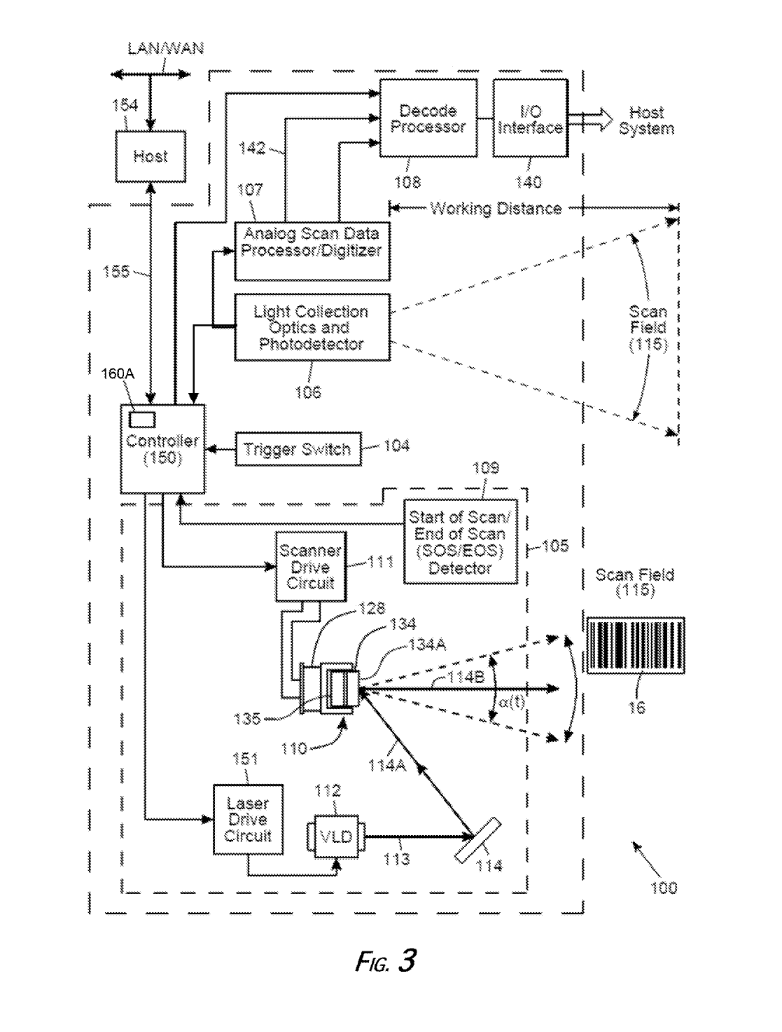

As shown in FIG. 3, an exemplary embodiment of the system 100 includes a distance detector module that includes a processor 160A. The processor 160A detects the distance from the system 100 to the code symbol 16 in response to the first signal obtained from the photodetector 106. Typically, when the object bearing the code symbol 16 is in the near field of the code symbol reading system's 100 working distance the intensity of the collected light will be greater, for example due to less scatter. This results in the first signal generated by the photodetector 106 being relatively strong. When the processor 160A analyzes the first signal and determines the signal to be relatively strong, it detects that the code symbol 16 must be in the near range. When the code symbol 16 is at the far range of the working area, the intensity of the collected light can be significantly reduced from intensity levels in the near range (e.g., 1600 times less than intensity levels in the near range). The resulting first signal corresponding to the light intensity is therefore typically relatively weak. Consequently, when the processor 160A analyzes the first signal and determines that it is relatively weak, the processor 160A determines that the code symbol 16 is in the far range. The sweep angle is adjusted according to the distance detected by the processor 160A.

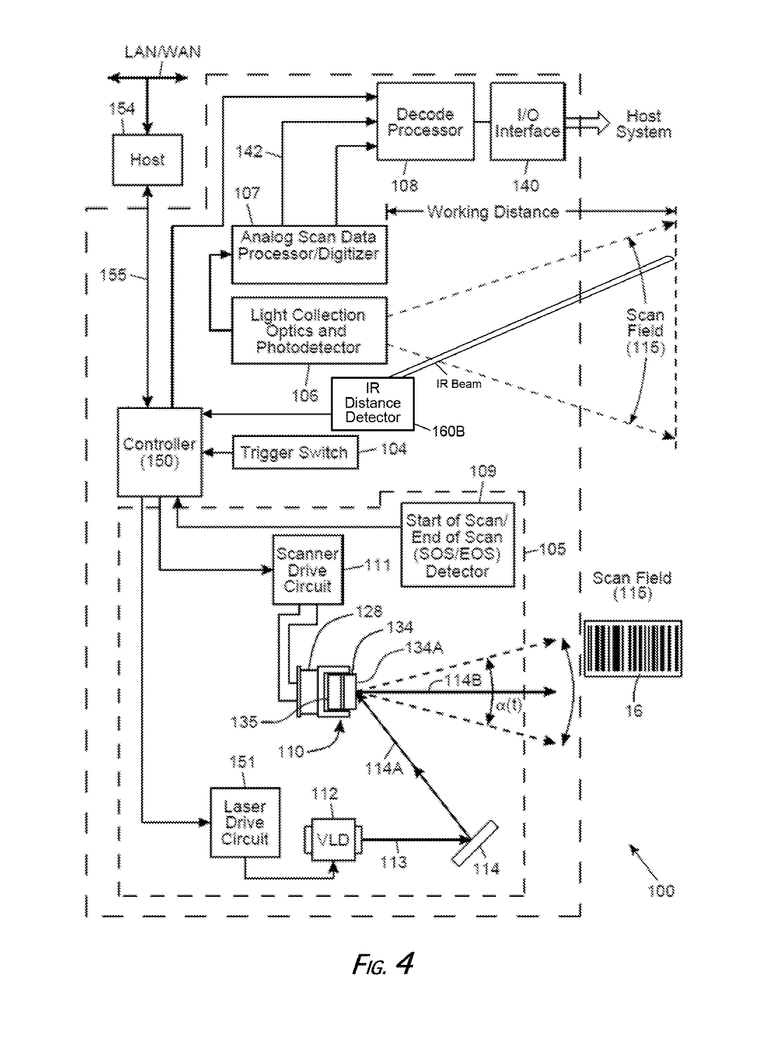

An alternative embodiment of the system 100 according to the present disclosure is presented in FIG. 4. In this embodiment, the distance between the system 100 and the code symbol 16 is determined by an infrared distance detector (IR detector) 160B. The IR detector projects an IR beam toward the scanning field 115, and analyzes the reflected IR signal to determine the distance. The sweep angle is then adjusted according to the distance detected by the IR detector 160B. It will be appreciated by a person of ordinary skill in the art that distance detected may actually be the distance between the system 100 and the object bearing the code symbol 16, which distance typically would approximate the distance between the system 100 and the code symbol 16.

To supplement the present disclosure, this application incorporates entirely by reference the following patents, patent application publications, and patent applications: U.S. Pat. No. 6,832,725; U.S. Pat. No. 7,159,783; U.S. Pat. No. 7,413,127; U.S. Pat. No. 8,390,909; U.S. Pat. No. 8,294,969; U.S. Pat. No. 8,408,469; U.S. Pat. No. 8,408,468; U.S. Pat. No. 8,381,979; U.S. Pat. No. 8,408,464; U.S. Pat. No. 8,317,105; U.S. Pat. No. 8,366,005; U.S. Pat. No. 8,424,768; U.S. Pat. No. 8,322,622; U.S. Pat. No. 8,371,507; U.S. Pat. No. 8,376,233; U.S. Pat. No. 8,457,013; U.S. Pat. No. 8,448,863; U.S. Patent Application Publication No. 2012/0111946; U.S. Patent Application Publication No. 2012/0223141; U.S. Patent Application Publication No. 2012/0193423; U.S. Patent Application Publication No. 2012/0203647; U.S. Patent Application Publication No. 2012/0248188; U.S. Patent Application Publication No. 2012/0228382; U.S. Patent Application Publication No. 2012/0193407; U.S. Patent Application Publication No. 2012/0168511; U.S. Patent Application Publication No. 2012/0168512; U.S. Patent Application Publication No. 2010/0177749; U.S. Patent Application Publication No. 2010/0177080; U.S. Patent Application Publication No. 2010/0177707; U.S. Patent Application Publication No. 2010/0177076; U.S. Patent Application Publication No. 2009/0134221; U.S. Patent Application Publication No. 2012/0318869; U.S. Patent Application Publication No. 2013/0043312; U.S. Patent Application Publication No. 2013/0068840; U.S. Patent Application Publication No. 2013/0070322; U.S. Patent Application Publication No. 2013/0075168; U.S. Patent Application Publication No. 2013/0056285; U.S. Patent Application Publication No. 2013/0075464; U.S. Patent Application Publication No. 2013/0082104; U.S. Patent Application Publication No. 2010/0225757; U.S. patent application Ser. No. 13/347,219 for an OMNIDIRECTIONAL LASER SCANNING BAR CODE SYMBOL READER GENERATING A LASER SCANNING PATTERN WITH A HIGHLY NON-UNIFORM SCAN DENSITY WITH RESPECT TO LINE ORIENTATION, filed Jan. 10, 2012 (Good); U.S. patent application Ser. No. 13/347,193 for a HYBRID-TYPE BIOPTICAL LASER SCANNING AND DIGITAL IMAGING SYSTEM EMPLOYING DIGITAL IMAGER WITH FIELD OF VIEW OVERLAPPING FIELD OF FIELD OF LASER SCANNING SUBSYSTEM, filed Jan. 10, 2012 (Kearney et al.); U.S. patent application Ser. No. 13/367,047 for LASER SCANNING MODULES EMBODYING SILICONE SCAN ELEMENT WITH TORSIONAL HINGES, filed Feb. 6, 2012 (Feng et al.); U.S. patent application Ser. No. 13/400,748 for a LASER SCANNING BAR CODE SYMBOL READING SYSTEM HAVING INTELLIGENT SCAN SWEEP ANGLE ADJUSTMENT CAPABILITIES OVER THE WORKING RANGE OF THE SYSTEM FOR OPTIMIZED BAR CODE SYMBOL READING PERFORMANCE, filed Feb. 21, 2012 (Wilz); U.S. patent application Ser. No. 13/432,197 for a LASER SCANNING SYSTEM USING LASER BEAM SOURCES FOR PRODUCING LONG AND SHORT WAVELENGTHS IN COMBINATION WITH BEAM-WAIST EXTENDING OPTICS TO EXTEND THE DEPTH OF FIELD THEREOF WHILE RESOLVING HIGH RESOLUTION BAR CODE SYMBOLS HAVING MINIMUM CODE ELEMENT WIDTHS, filed Mar. 28, 2012 (Havens et al.); U.S. Patent Application No. 13/492,883 for a LASER SCANNING MODULE WITH ROTATABLY ADJUSTABLE LASER SCANNING ASSEMBLY, filed Jun. 10, 2012 (Hennick et al.); U.S. patent application Ser. No. 13/367,978 for a LASER SCANNING MODULE EMPLOYING AN ELASTOMERIC U-HINGE BASED LASER SCANNING ASSEMBLY, filed Feb. 7, 2012 (Feng et al.); U.S. patent application Ser. No. 13/852,097 for a System and Method for Capturing and Preserving Vehicle Event Data, filed Mar. 28, 2013 (Barker et al.); U.S. patent application Ser. No. 13/780,356 for a Mobile Device Having Object-Identification Interface, filed Feb. 28, 2013 (Samek et al.); U.S. patent application Ser. No. 13/780,158 for a Distraction Avoidance System, filed Feb. 28, 2013 (Sauerwein); U.S. patent application Ser. No. 13/784,933 for an Integrated Dimensioning and Weighing System, filed Mar. 5, 2013 (McCloskey et al.); U.S. patent application Ser. No. 13/785,177 for a Dimensioning System, filed Mar. 5, 2013 (McCloskey et al.); U.S. patent application Ser. No. 13/780,196 for Android Bound Service Camera Initialization, filed Feb. 28, 2013 (Todeschini et al.); U.S. patent application Ser. No. 13/792,322 for a Replaceable Connector, filed Mar. 11, 2013 (Skvoretz); U.S. patent application Ser. No. 13/780,271 for a Vehicle Computer System with Transparent Display, filed Feb. 28, 2013 (Fitch et al.); U.S. patent application Ser. No. 13/736,139 for an Electronic Device Enclosure, filed Jan. 8, 2013 (Chaney); U.S. patent application Ser. No. 13/771,508 for an Optical Redirection Adapter, filed Feb. 20, 2013 (Anderson); U.S. patent application Ser. No. 13/750,304 for Measuring Object Dimensions Using Mobile Computer, filed Jan. 25, 2013; U.S. patent application Ser. No. 13/471,973 for Terminals and Methods for Dimensioning Objects, filed May 15, 2012; U.S. patent application Ser. No. 13/895,846 for a Method of Programming a Symbol Reading System, filed Apr. 10, 2013 (Corcoran); U.S. patent application Ser. No. 13/867,386 for a Point of Sale (POS) Based Checkout System Supporting a Customer-Transparent Two-Factor Authentication Process During Product Checkout Operations, filed Apr. 22, 2013 (Cunningham et al.); U.S. patent application Ser. No. 13/888,884 for an Indicia Reading System Employing Digital Gain Control, filed May 7, 2013 (Xian et al.); U.S. patent application Ser. No. 13/895,616 for a Laser Scanning Code Symbol Reading System Employing Multi-Channel Scan Data Signal Processing with Synchronized Digital Gain Control (SDGC) for Full Range Scanning, filed May 16, 2013 (Xian et al.); U.S. patent application Ser. No. 13/897,512 for a Laser Scanning Code Symbol Reading System Providing Improved Control over the Length and Intensity Characteristics of a Laser Scan Line Projected Therefrom Using Laser Source Blanking Control, filed May 20, 2013 (Brady et al.); U.S. patent application Ser. No. 13/897,634 for a Laser Scanning Code Symbol Reading System Employing Programmable Decode Time-Window Filtering, filed May 20, 2013 (Wilz, Sr. et al.); U.S. patent application Ser. No. 13/902,242 for a System For Providing A Continuous Communication Link With A Symbol Reading Device, filed May 24, 2013 (Smith et al.); U.S. patent application Ser. No. 13/902,144, for a System and Method for Display of Information Using a Vehicle-Mount Computer, filed May 24, 2013 (Chamberlin); U.S. patent application Ser. No. 13/902,110 for a System and Method for Display of Information Using a Vehicle-Mount Computer, filed May 24, 2013 (Hollifield); U.S. patent application Ser. No. 13/912,262 for a Method of Error Correction for 3D Imaging Device, filed Jun. 7, 2013 (Jovanovski et al.) and U.S. patent application Ser. No. 13/912,702 for a System and Method for Reading Code Symbols at Long Range Using Source Power Control, filed Jun. 7, 2013 (Xian et al.).

In the specification and figures, typical embodiments of the invention have been disclosed. The present invention is not limited to such exemplary embodiments. Unless otherwise noted, specific terms have been used in a generic and descriptive sense and not for purposes of limitation.

What is claimed is:

1. A system for reading code symbols, comprising:
a source for generating a light beam;
a scanning element for scanning the light beam at a sweep angle across a scanning field;
a photodetector for detecting the intensity of light reflected from the scanning field and generating a first signal corresponding to the detected light intensity; and
a distance detection module for determining the distance between the system and the code symbol;
wherein the scanning element controls the size of the sweep angle based upon the distance between the system and the code symbol.

2. The system of claim 1, wherein the distance detection module comprises a processor.

3. The system of claim 2, wherein the processor determines the distance between the system and the code symbol based upon the first signal.

4. The system of claim 1, wherein the distance detection module comprises an infrared sensor.

5. The system of claim 1, wherein:
when the detected distance between the system and the code symbol is in a near range, the scanning element scans the light beam at a first sweep angle; and
when the detected distance between the system and the code symbol is in a far range, the scanning element scans the light beam at a second sweep angle.

6. The system of claim 5 wherein the first sweep angle is larger than the second sweep angle.

7. The system of claim 1, wherein the source for generating a light beam comprises a laser source.

8. A method for reading a code symbol with a code symbol reader, comprising:
generating a light beam;
scanning the light beam at a sweep angle across a scanning field;
detecting the intensity of light reflected from the scanning field;
generating a first signal corresponding to the detected intensity of light reflected from the scanning field;
determining a distance between the code symbol reader and the code symbol; and
controlling the size of the sweep angle in response to the determined distance between the code symbol reader and the object.

9. The method of claim 8, comprising determining the distance between the code symbol reader and an object in the scanning field based upon the first signal.

10. The method of claim 8, comprising determining the distance between the code symbol reader and an object in the scanning field by analyzing the first signal with a processor.

11. The method of claim 8, comprising determining the distance between the code symbol reader and an object in the scanning field via an infrared sensor.

12. The method of claim 8, comprising:
scanning the light beam at a first sweep angle when the detected distance between the system and the code symbol is in a near range; and
scanning the light beam at a second sweep angle when the detected distance between the system and the code symbol is in a far range.

13. The method of claim 12, wherein the first sweep angle is greater than the second sweep angle.

14. The method of claim 12, wherein the first sweep angle is equal to the code symbol reader's maximum field of view.

15. The method of claim 14, wherein the code symbol reader's maximum field of view is suitable for reading an entire code symbol located in the far range.

16. The method of claim 12, wherein the second sweep angle is equal to the code symbol reader's minimum field of view.

17. The method of claim 16, wherein the second sweep angle is suitable for reading an entire code symbol located in the near range.

18. The method of claim 8, comprising generating a light beam via a laser source.

19. The method of claim 8, comprising generating a light beam via an infrared light source.

20. The method of claim 8, comprising determining the distance between the code symbol reader and an object in the scanning field by determining whether the object in the scanning field is located in the near field.
